(19) United States
(12) Patent Application Publication
(10) Pub. No.: US 2010/0263600 A1
(43) Pub. Date: Oct. 21, 2010

(54) METHOD FOR OBTAINING OYSTERS RESISTANT TO PATHOGENIC AGENTS

(76) Inventor: Guy Lebrun, Brissac Quince (FR)

Correspondence Address: ARENT FOX LLP, 1050 CONNECTICUT AVENUE, N.W., SUITE 400, WASHINGTON, DC, 20036, US

(21) Appl. No.: 12/673,446

(22) PCT Filed: Aug. 12, 2008
(86) PCT No.: PCT/FR2008/001187

§ 371 Date: Jun. 30, 2010

(30) Foreign Application Priority Data
Aug. 14, 2007 (FR) 07/05850

(51) Int. Cl. A01K 61/00

(52) U.S. Cl. 119/234

(57) ABSTRACT

The present invention relates to a method for obtaining oysters resistant to pathogenic agents and to the resulting oysters. The method of the invention comprises the hybridization of a Mediterranean oyster Ostrea edulis resistant to said pathogenic agents and of a non-resistant oyster of the opposite sex. The present invention is in particular of use in the commercial production of farmed oysters resistant to pathogenic agents, such as Bonamia ostreae and Martelia refringens.

### TECHNICAL FIELD

The present invention relates to a method for obtaining oysters resistant to pathogenic agents and to the resulting oysters.

The present invention more particularly is of use in the commercial production of farmed oysters resistant to pathogenic agents such as Bonamia ostreae and Martelia refringens.

In the description hereinunder, the references between square brackets ([ ] refer to the list of references given after the examples.

### STATE OF THE ART

The flat oyster Ostrea edulis is one of the most farmed oysters in Europe but also in the United States as well as in Canada.

In the years 1970-1980, the appearance of the parasites Martelia refringens and Bonamia ostreae resulted in a significant reduction in the production of oysters thus leading oyster farmers to search for means to fight such parasites.

Several measures have been taken to limit the infection of oysters. One of the measures consisted in limiting the displacement of oysters from one hatchery to another and to limit the displacement of spat oysters from one region to another.

Another measure consisted in trying to select oysters resisting to parasites Bonamia Ostreae, Naciri-Graven et al. (1998) “Selecting the flat oyster Ostrea edulis (L.) for survival when infected with the parasite Bonamia ostreae” J. Exp. Mar Biol. Ecol., 224:91-107 [1]. Such selections made it possible to promote oysters tolerant but not resistant to said parasites and entailed the weakening of the genetic diversity of farmed oysters as well as a detrimental increase in consanguinity of oysters, N. Taris et al. “Conséquences génétiques de la production des larves d'huîtres en écloserie étude des processus de dérive et de sélection.”, Les actes du BRG, 6 (2006) 521-541. [2].

Other studies were made identifying non-infected areas for farming oysters using sensitive spat oysters from the Atlantic. One of these studies was led in Corsica in the 80s in Etang de Diana (Pond of Diane) leading to the classification of such pond as an infected area following the proposal from IFREMER, by virtue of the European Council Directive 91/67/CEE relating to animal health conditions regulating aquaculture products. Zone 1 which surrounds the whole of Corsica is classified as not bonamiosis and marteliosis free.

The various studies made it possible to draw a map of the areas infected by the parasites and even to select, in each area, more parasite-tolerant oysters, but this weakened their genetic diversity.

None of such studies made it possible to produce oysters resistant to said parasites.

Thus there is a real need for a method making it possible to obtain oysters resistant to pathogenic agents remedying the defects, drawbacks and obstacles of the prior art and making it possible to master an industrial production at reduced costs. This method must also be easily implemented.

### DESCRIPTION OF THE INVENTION

The present invention more precisely aims at meeting the needs and drawbacks mentioned above by providing a method for obtaining oysters resistant to pathogenic agents.

The method of the invention is characterized in that it comprises the hybridization of a Mediterranean oyster Ostrea edulis resistant to such pathogenic agents and of a non-resistant oyster.

The invention also relates to oysters resistant to pathogenic agents liable to be obtained with the method of the invention.

According to the invention, “resistant oysters” means any Mediterranean oyster Ostrea edulis resistant to pathogenic agents. The resistant Mediterranean oyster Ostrea edulis may be any wild oyster resistant to agents and originating from the Mediterranean Sea. For example, all the Mediterranean oysters Ostrea edulis not having been submitted to a selective pressure of anthropogenic origin nor genetic contamination, for example by culture and/or transplantation of cultured strains originating from the Atlantic. The Mediterranean origin of the oysters can be checked through molecular analyses of the strains with allozyme markers or microsatellites markers, Launey S. et al. “Geographic structure in the European flat oyster (Ostrea edulis L.) as revealed by Microsatellite polymorphism.” J Hered. 2002 September-October; 93(5):331-51. (2002) [3], or RNA sequences. For example, a molecular marker which can be used so as to show the Mediterranean origin of the layer corresponds to the sequence of 313 pairs of bases of the mitochondrial 12s-rRNA gene of the strains such as mentioned in the scientific article Diaz-Almela et al. “Reduced female gene flow in the European flat oyster Ostrea edulis”. J Hered. 2004 November-December; 95(6):510-6. (2004) [4].

The resistant oysters may be selected so as to have preferably zootechnical qualities of growth and condition indices, which means the ratio of eatable meat with respect to the total weight, which are the most adapted to the hybridization method. For example, said ratio can be between 0.10 and 0.20, preferably above 0.15. The measurement can be carried out, for example, on the biggest oysters within a class of age and having an adapted conformation of the shell, which means a convex lower half shell. The resistant oysters may be selected, for example, among young first maturity oysters, for example having a weight of less than 80 g as for the Corsican oyster, the biggest oysters having a tendency to produce a bigger proportion of shell. Among these, the oysters having a convexity defined as being the ratio of the thickness on the average diameter [(length+width)/2], above 0.33 can be preferably chosen.

Resistant oysters can be chosen as a function of their phenotypic characteristics such as size, weight, etc. For example, the resistant Mediterranean oyster Ostrea edulis may be selected preferably with a diameter above 60 mm.

Resistant oysters can also be selected as a function of their location as regards the natural growing medium. For example, between the free forms, disseminated on the surface of the sediment and the oysters fixed on rocks in their natural medium, free forms are preferred since they represent characteristics which are more adapted to farming.

Oysters sampling areas in natural sites are preferably those including the most important population which means the highest productivity. As for free forms occupying the soft sediment, oysters can be, for example, selected among the populations having a density above 1 individual per m² and preferably above 2 individuals per m².

The resistant oyster Ostrea edulis can be selected, for example, among the resistant Mediterranean oysters Ostrea edulis, the oysters originating from the Corsican lagoons, from Morocco in Nador, from Tunisia in Gabes, from Libya, from Greece, from Murcia in the Mar Menor in Spain, the Aegean region at the Bosphorus in Turkey, Minorca in the Balearic islands, Ukraine in Sevastopol, the Red Sea and/or the Baltic Sea.

Preferably, for embodying the method of the invention, the resistant oyster Ostrea edulis is selected among the group including the wild Corsican oyster Ostrea edulis from Pond of Diane, Etang d′Urbino, the gulf of Porto Vecchio, the gulf of Santa Manza and Sardinia lagoons. Preferably, for the embodiment of the method of the invention, the selected resistant oyster Ostrea edulis is the wild Corsican oyster Ostrea edulis from Pond of Diane.

According to the invention, the resistant Mediterranean oysters can be oysters originating from old Mediterranean populations. The oysters are preferably wild flat oysters which have not been submitted to external genetic changes resulting from transplantations or farming and/or oysters originating from geographically limited Mediterranean lagoons. The wild populations residing for a long time in Mediterranean lagoons have genotypic, phenotypic and zootechnical characteristics which are proper to the changes in particular adaptive qualities linked to their biotope more particularly the levels and amplitudes of temperatures, the levels and variations in salinity, the oxygenation of the medium, the trophic qualities of the medium and the tides and the possible resistance to land emergence of natural populations. For example, the natural populations of oysters in the Nador lagoon in Morocco can be uncovered for several hours during high tides and submitted to the region sub-tropical sunlight without dying. The resistant oyster can be an oyster from Nador for the embodiment of the method of the invention for example to obtain a hybrid adapted to the tidal zone farming in the Atlantic.

However, the resistant Mediterranean strains originating from open biotopes with a low food supply inherit common adaptive characteristics which are generally not very favourable to the quality of hybridization. This is the case for the resistant strains originating from the Greek islands of Cyclades, Croatia, Calabria, Sicily and the Camargue (Port-Saint-Louis-du-Rhône).

The Mediterranean origin of the oysters can be checked for example through molecular analyses of the strains by allozyme markers, microsatellite markers [3] or RNA sequences [4] as previously described.

According to the invention, the selected resistant oyster advantageously has a level of carbohydrate storage materials which is appropriate for hybridization. Such storage materials which are composed of glycogen will progressively give the aspect of a “fatty” oyster which can develop its gonad and produce its gametes. Such storage materials can be used in spring for manufacturing the gametes and during the whole gametogenesis; thus, the nutrition of the spawners determines fertility and recruitment. Carbohydrate storage materials favour the expression of the full fertility of the oysters and thus the realization of the method of the invention.

According to the invention, the resistant Mediterranean oyster Ostrea edulis is preferably selected at the farming age, preferably the first farming age. The selection of the oyster at the first farming age makes it possible to guarantee a maximum survival rate of the gametes for carrying out the hybridization.

According to the invention, “non-resistant oysters” means any sensitive oyster vulnerable to pathogenic agents, whatever the origin, genus or species thereof. The non-resistance of the oyster to pathogenic agents can appear through any alteration of the biological functions of the oyster which can, for example, entail a modified, reduced or stopped growth of the oyster. The non-resistance to pathogenic agents can also lead to the death of the oyster. In the case of bonamiosis, the first indication of the infection often arises further to a slowed growth, damages on gills, opening of the valves together with high mortality generally appearing as from the first sexual maturation. As for marteliosis, also called “Aber disease”, the following clinical signs appear in farms either in rias or other tidal zones: emaciation and depletion of glycogen storages, complete discolouration of the digestive gland, stoppage of feeding and weakening of the oyster, which are signs followed with a high mortality.

In other terms, the non-resistant oyster can be any oyster sensitive to the pathologies of the farmed oysters. This can be, for example, a bivalve oyster of the Ostreid family.

For example, the non-resistant oyster can be an oyster sensitive to oysters' herpes virus 1 (“Ostreid Herpesvirus-1 (OsHV-1)”).

For example, the non-resistant oyster can be an oyster the immune defence of which is weakened because of changes in environmental factors: toxic elements, contaminants or physicochemical factors of the environment (Gagnaire B., 2005) [10].

For example, the non-resistant oyster can also be an oyster made sensitive to infectious agents through a genetic drift resulting from cultural practices or pressure on the selection in the hatchery, (Tans N., 2007) [15].

According to the invention, the non-resistant oysters which can by hybridized according to the method of the present invention can be selected among the wild oysters, the farmed oysters, obtained by natural collections or in hatcheries, the native oysters strains, the Mediterranean indigenous oysters and the oysters originating from outside the Mediterranean Sea. For example, the non-resistant oyster can be an oyster from the Atlantic, the Pacific and/or the Indian Ocean.

According to the invention, the non-resistant oyster can for example be a Mediterranean oyster degenerated by oyster farming practices or polluted by the transfer of sensitive and/or contaminated oysters from the Atlantic, the Pacific and/or the Indian Ocean.

According to the invention, a non-resistant oyster can be of a genus or a species identical to or different from the resistant oyster Ostrea edulis. It can be for example a flat or a Portuguese oyster. For example, non-resistant oyster species which can be used in the invention can belong to the following genus and/or species, without being limited thereto, Ostrea edulis, Ostrea angasi, Ostrea conchaphila, Ostrea lurida, Ostrea denselamellosa, Ostrea puelchana, Ostrea folium, Ostrea permollis, Ostrea stentina, Tiostrea chilensis, Crassoster virginica, Crassostrea gasar and Crassostrea Rhizoporae, etc.

The non-resistant oyster can be selected, for example, from the group including Crassostrea gasar which is the oyster of the mangrove tree, estuaries and mangroves in Western Africa, Crassostrea Rhizophorae, a mangrove tree oyster, Indo-Pacific, etc.

The non-resistant oyster Ostrea edulis can be selected, for example, from the group including flat oysters from the Etang de Than “Bouzigues”, oysters from the lagoon in Venice: flat oyster from Venice, flat oysters from the Bassin d'Arcachon “Gravettes”, from Charente and/or Vendee, flat oyster from south Brittany “Delon” originating from rias and the Gulf of Morbihan, “Cancales” originating from north Brittany and Normandy, oysters originating from Galicia in Spain, oysters originating from Portugal, oysters from Great Britain, Cornwall, oysters from the south and north of Ireland, oysters from the Netherlands, oysters from Denmark, oysters from the United States and Canada, Western Atlantic, from Florida to Quebec, oysters from the East Pacific originating from the coasts of the USA and Canada, oysters from the coasts between California and Alaska.

Non-resistant oysters can be infected or not infected, tolerant or not tolerant to pathogenic agents for the implementing of the method of the invention. Said oyster is said tolerant when it is liable to reproduce for the first time before expressing the pathologies it bears.

According to the invention, for the implementation of the method of the invention, the resistant Mediterranean oyster Ostrea edulis and the non-resistant oyster are preferably selected after a period of sexual latency. Such period normally occurs in winter. Such resistant and non-resistant oysters are then preferably conditioned for hybridization, for example in a hatchery tank, for example in an increasing photoperiod.

According to the invention, the oysters can be separately marked as a function of the resistant or non-resistant to pathogenic agents characteristic. The marking can be carried out by any means known to the persons skilled in the art, for example through scarification or fixing of labels using glue, for example epoxy glue. Such individual marking of oysters makes it possible to compose homogeneous batches of hybrid spat oysters.

According to the invention, oysters used for hybridization are of opposite sexes. The flat oyster of the Ostrea genus is an asynchronous bivalve with a rhythmic consecutive sexuality. Generally protandric, it can change sex several times during the same season, which makes sexing difficult since male and female lines exist simultaneously. This specific mode of reproduction linked to the Ostrea genus prevents any control of genetic identity in case of mass reproduction. Thus, it is preferred to isolate the oysters two by two in the case where hybridization concerns resistant and non-resistant oysters of the Ostrea genus. In other terms, it is thus preferred to isolate the oysters two by two. Theoretically, each pair of isolated oysters should have only one chance out of two to be a male-female couple. Advantageously, in the present invention, fertilization occurs for 70 to 80% of the couples. As a matter of fact, the maturation of the most precocious oyster can cause a reverse orientation of the sex of the second oyster. The number of hybridizations obtained by the present invention is thus higher than the assumed theoretical number.

It should be noted that oysters are more often eurythermal and euryhaline. Such tolerances facilitate the synchronisation of the maturations and the emission of the gametes, as well as the hybridization of two oysters originating from singular geographic medium.

According to the invention, the pathogenic agents can be selected from the group including bacteria, parasites and viruses.

According to the invention, “pathogenic agents” means a unique pathogenic agent or several pathogenic agents or the unique pathogenic agents or in combination with other agents, responsible for bacterial, viral pathologies, parasitoses or pathologies associated therewith.

According to the invention, the pathogenic agents can be selected from the group including the haplosporidia, the protozoa, the martelia, the parasites and the external contaminating agents calling for the general cellular and/or humeral immunity mechanisms in the oysters, for example the pathogenic agents Bonamia ostreae and Martela refringens.

According to the invention, said pathogenic agents can be responsible for pathologies, for example bonamiosis, marteliosis, haplosporidosis, microcytosis, perkinsosis and/or irivovirosis, preferably the pathogenic agents are responsible for bonamiosis and/or marteliosis.

According to the invention, said pathogenic agents can be responsible for epizootics, massive or recurring mortality syndromes, for example summer mortality associated for example with the increase in temperature of the culture medium and/or the herpes virus 1 of the oyster (“Ostreid Herpesvirus-1 (OsHV-1)”) and to opportunistic agents, for example Nocardia crassostreae. Such pathogenic and/or opportunistic agents described in molluscs of economic interests are grouped in the “Synopsis of Infectious Diseases and Parasites of Commercially Exploited Shellfish” (Bower et al., 1994) [13], (Bower & McGladerry, 2003) [14]).

Means for implementing the method of the present invention are described hereinafter.

According to the invention, hybridization can be carried out in any tank known to the persons skilled in the art enabling the performance of hybridization of oysters. For example, the tank can be a nursery container, an aquarium, any tank, container or basin made of glass, wood, metal, synthetic material or masonry or any adapted vessel. The volume of the tank used for the realisation of the method of the invention can for example be of a volume of 1 to 100 litres, preferably 5 to 20 litres.

According to the invention, the tank may include water oxygenation means. For example, water can be oxygenated using any means known to the persons skilled in the art, for example a pump enabling the expulsion of air into the water of the tank. Oxygenation can also be performed at the water circuit level. The oxygenation rate of water can be adapted during the realisation of hybridization, preferably with a view to saturating the aquatic medium with dissolved oxygen whatever the levels of temperature and salinity required according to the invention. The level of oxygen can be 5 mg/l to 11 mg/l, preferably above 6.5 mg/l. According to the invention, the tank including the oysters to be hybridized can be, for example, previously filled with water, continuously or discontinuously supplied by a water circuit. The water circulation rate can be between 01/h and 1001/h, preferably between 51/h and 201/h. The rate can be adjusted to the breathing and feeding requirements of oysters and larvae.

According to the invention, said water circuit can be isolated from one tank to another. The isolation of the water circuit more particularly makes it possible to avoid external influences on the oysters to be hybridized and thus to guarantee the purity of hybrid larvae. Such isolation makes it possible, for example, to prevent the production of hybrids with undesirable genetic contaminations.

According to the invention, the water used in the present invention can be any water adapted to the performance of hybridization. The water adapted to the performance of the invention can be, for example, water having physicochemical characteristics, for example salinity, pH, temperature, etc., which are identical to, intermediary of or different from those of the original medium of non-resistant oysters and/or those of the medium of resistant oysters.

According to the invention, water can have a different composition as a function of the steps of the method of the invention.

According to the invention, the water used can have salinity between 3‰ and 50‰ preferably between 12‰ and 38‰. It can have a pH between 6.5 and 9, preferably between 7 and 8.5. It can have a temperature between −8° and +55° C., preferably between 12° and 40° C.

According to the invention, the food supply for the realisation of the invention can be composed of any food source known to the persons skilled in the art for farming oysters and/or hybridizing oysters. Said food supply can be composed, for example, of unicellular algae, phytoplankton, benthic bacteria for the supply of food micro-particles, composed food products, supply of dissolved organic materials such as carbohydrates, proteins, vitamins, etc. or a combination thereof.

Phytoplankton, benthic bacteria as well as unicellular algae can originate from hatcheries and/or the natural culture medium of oysters. Micro-particles can have a natural or an artificial origin, for example it can originate from organic wastes and/or aqua-cultural wastes.

Unicellular algae and/or phytoplankton can, for example, be concentrated by centrifugation in the form of a cooled paste, the food micro-particles can for example be suspended and/or in emulsion, composed food can be for example dry or hydrated, associated glycidic and/or lipidic and/or proteic matters possibly extruded, calibrated or microcapsulated.

Unicellular algae grown in hatcheries and/or natural medium can be selected from the group including Isochrysis galbana, Skeletonema costanum, Pavlova lutheri, Chaetoceros calcitrans, Tetraselmis sp., etc. For example, phytoplankton can be selected from the group including: Isochrysis galbana, Pavlova lutheri, Chaetoceros forma pumilum, etc. The quantity and quality of phytoplankton and of the unicellular algae used are preferably adapted to the realisation of the method of the invention. Nutrition is an important element for the fertility of spawners and the successful recruitment of larvae and hybrid oysters.

In the present document, “hybridization” means any method known to the persons skilled in the art enabling the realisation of an hybridization between at least one resistant oyster and one non-resistant oyster such as described hereabove. Hybridization can also be directly realised with gametes of resistant and/or non-resistant oysters as described above using the sperm cryopreservation techniques according to the studies by Lannan J. E, 1971, Experimental self-fertilization of the Pacific oyster, Crassostrea gigas, utilising cryopreserved sperm, Genetics, 68:599-601 [5], Bougrier and Rabedomanana, 1986. Cryopreservation of spermatozoa of the Japanese oyster, Crassostreea gigas. Aquaculture, 58:227-280 [6], or using multi-specific preservation and washing dilutors of gametes Haffray et al. “Domestication et amelioration génétique des cheptels piscicoles dans le cadre du SYSAAF”, INRA Prod. Anim., 2004, 17 (3), 243-252 [7]. Zootechnical knowledge can make it possible to master the artificial reproduction of identified individuals through sex control, through the individual maturation of spawners, through the synchronisation of egg-laying and chemical exchanges between the spawners. Such knowledge was the subject of a scientific synthetical publication: Gerard A., Naciri-Graven Y., Boudry P., Launey S., Heutebise S., Ledu C., Phelipot P., (1997). Controle de la gamétogenèse des huîtres creuses et plates. In: La production naturelle et contrôlée des Bivalves cultivés en France, Devauchelle N., Barret J., Salaun G., (1997), DRV/RA/RST 97-11, Ifremer Brest, 217 pp. [8].

According to a particular embodiment of the invention, hybridization can include the following steps:

a) supplying a Mediterranean oyster Ostrea edulis resistant to said pathogenic agents,
b) supplying a non-resistant oyster to said pathogenic agents, the sex of which is opposite to the one of said resistant oyster Ostrea edulis,
c) placing together said oysters in a tank containing water having a salinity enabling hybridization,
d) maturation of said oysters in said tank, with an increasing photoperiod with food supply sufficient for said maturation,
e) induction of the emission of male gametes using an induction agent applied to the oysters,
f) fertilization of the female gametes by the male gametes emitted in step e),
g) incubation of larvae obtained in step f) for 8 to 10 days,
h) feeding of the larvae obtained in step by phytoplankton so as to obtain eyed larvae,
i) collection of the obtained eyed larvae, and
j) fixation of said larvae on a development support in order to obtain at least one oyster resistant to said pathogenic agents.

According to the method of the invention, the Mediterranean oyster Ostrea edulis resistant to pathogenic agents supplied in step a) is a resistant oyster as described hereabove.

According to the method of the invention, the oyster non-resistant to pathogenic agents supplied in step b) is a non-resistant oyster such as described hereabove.

According to the method of the invention, step c) consists in putting together at least one oyster obtained in step a) and at least one oyster obtained in step b) into a tank.

For example, several oysters obtained in step a) can be put with one oyster of step b) into a tank and reversely. Several oysters obtained in step a) can also be put together with several oysters obtained in step b) into a tank.

Preferably, said oysters supplied in steps a) and b) in the method according to the invention are isolated two by two in step c) of the method of the invention, i.e. each tank contains only two oysters, one corresponding to an oyster obtained in step a) and the other corresponding to the oyster supplied in step b).

The tank used in the method of the invention can be a tank as described hereabove.

The steps d) to i) can be carried out with the above-mentioned implementation means. Such means can be adapted to each step of the method of the invention.

According to the method of the invention, the maturation carried out in step d) of the method of the invention can be carried out by any means known to the persons skilled in the art enabling the maturation of the oysters. Preferably, the maturation of oysters is carried out through a progressive increase in photoperiod. This increase can be carried out on a period of one week to 6 months, preferably 1 month to 3 months. The minimum lighting time is between 1 hr and 12 hrs, the maximum lighting time can be between 12 hrs and 23 hrs. The step of maturation can be carried out at any temperature enabling the realisation of the method of the invention. Preferably, said maturation can be carried out through the progressive increase in the temperature up to a temperature preferably between 20 and 30° C. Preferably, maturation is carried out at a temperature between 20 and 30° C. The selection of the final maturation temperature more particularly depends on the strains used during the method of hybridization and their response to maturation. The temperature can be adapted as a function of the oysters to be hybridized. The control of the answer of the oysters in this step can be carried out through the control of maturity of the gonads and the formation of the gametes. Oysters have different maturity phases numbered from 0, which corresponds to sexual latency, to 4b corresponding to the emission of gametes. The control of maturity can be carried out using methods known to the persons skilled in the art, for example the observation of the opening of valves in an anaesthetic bathing using magnesium chloride (MgCl₂). In the method of the invention, the oyster is considered as mature when it has reached stage 3 of the gonad maturation.

During this step of maturation, the food supply can be carried out by any appropriate means known to the persons skilled in the art. It can be, for example, food supply such as previously defined. It can be, for example, unicellular algae, phytoplankton, benthic bacteria, food micro-particles, etc.

In a particular embodiment wherein the tank is supplied by a water circuit during the maturation step, said circuit can be isolated from one tank to another. The isolation of the water circuit makes it possible, among other things, to avoid the exchanges of water from one tank to another and thus the exchanges of substances, for example proteins and/or pathogenic agents and/or chemical substances which can be emitted by mature oysters bred in other tanks. Such substances can be capable of determining the sex of spawners. The exchanges of gametes emitted by mature oysters bred in other tanks which is undesirable for the realisation of the invention, can cause undesired self-fertilization between sister lines.

According to the invention, the induction of the emission of gametes which is defined in step e) of the method of the invention is preferably carried out on mature oysters, for example, oysters at stage 3 of the maturation of the gonads. Such mature oysters can be, for example, the oysters obtained in step d) of the method of the invention. The agent of induction used in step e) of the method of the invention can be any means of induction known to the persons skilled in the art, for example, at least a thermal shock and/or at least a protein for example a hormone, a chemical substance or a neurotransmitter, for example serotonin.

Preferably, the induction agent can be one or several thermal shock or shocks. It corresponds to successive reduction and increase in temperature, the variation in temperature being adapted to the realisation of the method of the invention. For example, the maximum temperature can be between 25° C. and 55° C. and the minimum temperature between 5° C. and 20° C.

The induction, for example, the thermal shock enables the emission of male gametes first, which stimulates the laying of female gametes. The induction of the emission of female gametes is chemically realised by the male gametes. It can, for example, be a hormone or a neurotransmitter, for example serotonin.

The induction of the emission of female gametes can also be carried out by any substance known to the persons skilled in the art inducing the emission of female gametes. For example, a chemical substance, a hormone or a neurotransmitter, for example serotonin, for example water containing male gametes, filtered water having contained gametes and/or a dilution medium containing active sperm originating from cryopreservation.

In a particular embodiment, the step e) of induction of the emission of gametes of the oysters is preferably carried out in a tank without any water circulation so as to prevent the dispersion of the gametes. In this case, if water circulation occurs in the previous steps, for this step e) the water circuit is closed.

In another particular embodiment of step e), the circulation of water from one tank to another can also be isolated in order to prevent the dispersion of substances such as hormones or male gametes in the other tanks.

According to the method of the invention, the step f) corresponds to the fertilization of the female gametes by the male gametes, the male gametes being previously filtered by the female oyster. Fertilization occurs in the mantle cavity of the oyster. The means of implementation of this step can be those previously described or any means known the persons skilled in the art. These means are, of course, preferably adapted to the realisation of fertilization.

According to the method of the invention, the incubation of larvae such as defined in step g) can be carried out preferably in the mantle cavity of the oyster. During this step of incubation of larvae, the means for implementing this step can be those described previously or any other means known the persons skilled in the art. Such means are preferably adapted to the realisation of such incubation. This step of incubation can be carried out for 8 to 10 days. During this step of incubation, the feeding of the oysters and the larvae can be carried out, for example, with phytoplankton such as described hereabove or any other appropriate food. After this period of incubation, the larvae are emitted into the medium.

According to the method of the invention, the steps e) and g) corresponding to the induction of egg-laying, fertilization and incubation of larvae can be carried out in vitro, out of the mantle cavity or in vivo inside the mantle cavity of the female. When step g) is carried out in vivo, which means in the mantle cavity of the female oyster, the gametes are filtered, fertilized and incubated in the mantle cavity of the female oyster. The incubation is carried out in such a way that it makes the expulsion of larvae possible in step g).

In vitro, the gametes are obtained by scarification of the gonads (the “stripping” technique), making it possible to programme and to control the stages of development and fertilization.

According to the method of the invention, the step h) corresponds to the feeding of the larvae emitted in the medium at step g) for obtaining eyed larvae. Phytoplankton enabling the feeding of larvae such as described above can be any phytoplankton known to the persons skilled in the art enabling the realisation of such step. The means for implementing such step can be those previously described or any means known to the persons skilled in the art. Such means are preferably adapted to the carrying out of the feeding of larvae.

According to the method of the invention, the step i) corresponds to the collection of the eyed larvae obtained in step h). The collection of eyed larvae can be carried out, for example, 8 to 10 days after the expulsion of larvae. The means for collecting eyed larvae can be any means known to the persons skilled in the art, for example filters, screens having pores with a diameter enabling the collection of larvae. For example, screens can have a mesh size from 10 μm to 180 μm, preferably from 50 μm to 150 μm. The mesh size can be selected as a function of the size of the emitted larvae, and the latter must be smaller than the size of the emitted larvae.

According to the method of the invention, the step j) corresponds to the fixation of the larvae on development supports. The fixation can be realised in tanks as described hereabove. The implementation means for this step can be those described hereabove or any means known to the persons skilled in the art. These means are preferably adapted to the realisation of fertilization. Said tanks can include on their walls identical or different development supports. Larvae development supports can be any support enabling the realisation of the method of the invention. For example, the development support can be micro-crushed oyster shells or mussel shells or micro-crushed glass and/or any material screened for example between 250 μm and 500 μm, which enables the succession of larvae obtained through the method of the invention and the obtaining of free spat oysters.

After the fixation step, spat oysters develop so as to obtain at least one hybrid oyster. The means for implementing such development step can be those described hereabove or any other means known to the persons skilled in the art. Such means are preferably adapted to the development of larvae.

According to the invention, hybridization can be carried out, for example, during only one breeding season, for example a period of six months during the first maturity year. Temperature and feeding conditions can be so selected as to enable each oyster to change sex several times during its first maturity. Said oysters are capable of emitting new gametes at intervals between 10 to 70 days.

Advantageously, the realisation of the method of the invention during the first maturity year can make it possible to have an optimal quality of gametes and larvae originating from young oysters.

Hybrid oysters obtained according to the method of the invention are of the full-brother type, they originate only from parents having particular genetic polymorphisms resulting from their distinct and complementary geographical and ecological identities added by heterozygozity. Such hybridization and formation of heterozygotes make it possible to obtain hybrids having characteristics of resistance to pathogenic agents.

Hybridization according to the method of the invention never happens in nature more particularly because of the biology of reproduction of the Ostrea genus and the geographical distance between genetically distinct wild populations. The system of farming usually uses F1 hybrid only, since heterosis qualities are rapidly lost in the following generations because of the consanguine degeneration to which Ostreids are particularly vulnerable. The method of the invention thus makes it possible to obtain first generation resistant oysters.

Resistant hybrid oysters can develop under various conditions. As a function of the hybridization obtained they can develop in the parents' original environment. For example, the cross of a Corsican resistant oyster Ostrea edulis with a non-resistant oyster from the Atlantic gives a hybrid resistant to pathogenic agents capable of developing on the Atlantic coasts and also the Mediterranean Sea coasts. Such aspect of the invention has a great advantage with respect to the state of the art, knowing that the resistant Corsican oyster cannot develop on the Atlantic coasts since the Corsican oysters are not adapted for example to the tide phenomenon and thus to the immersion and emergence phenomenon, the variations of the medium, for example salinity, temperature.

Resistant oysters obtained by hybridization, thanks to their resistance and their capacity of adaptation to the medium, make it possible to reduce costs and significantly improve the production of oysters in oyster farms infected by pathogenic agents.

The resistant oysters obtained with the method of the invention further have properties of adaptation to weather variations, for example increase in temperature of the culture medium.

In addition, hybrids can have a daily growth increased by up to 30% with respect to that of the parents from which they originate. This aspect increases the interest of using the resistant hybrids in oyster production farms.

Such resistant oysters obtained by hybridization can also make it possible to stock areas infected by pathogenic agents imported or not by man through the farming of infected oysters and to enable the restoration of a marine ecosystem.

Such resistant oysters obtained by hybridization also make it possible to regenerate the biodiversity of strains grown in oyster farms where consanguinity becomes more and more important. The consanguinity is a source of degeneration for the strain and the cause for the reduction in the productivity of oyster farms.

Consanguinity of oysters can cause a reduction in the resistance of oysters to pathogenic agents as it has been observed since 1920 through the multiplication of epizootic phenomena in oyster farms [16].

The resistant hybrid oysters obtained according to the present invention have increased properties of resistance to viral, bacterial and/or parasitive pathogenic agents known to the persons skilled in the art. The increased properties of resistance can be for example an increase in the cellular and humeral immune response, more particularly as far as haemocyte defence is concerned. Such properties can result, for example, from the restoration of the genetic diversity resulting from heterozygozity [15].

The resistant hybrid oysters obtained according to the invention make it possible to solve the problem of recurrent epizootics within oyster farms, from example epizootics resulting from the increase in the temperature of water or epizootics resulting from herpes virus 1 of oysters (“Ostreid Herpesvirus-1 (OsHV-1)”). As a matter of fact, the genetic diversity of the oysters obtained by the method of the invention gives them greater coarseness and immunity with respect to consanguine oysters thus making it possible to resist to episodic infections resulting from modifications in the environment and more particularly weather changes [10].

Other advantages will still appear to the persons skilled in the art when reading the examples hereinunder, which are given as an illustration.

### EXAMPLES

### Example 1

### Resistant Oyster Ostrea edulis from the Pond of Diane in Corsica

Wild oysters were collected from the pond of Diane, a pond considered as from the 1980s as contaminated by parasites Bonamia ostreae and Marteliae refringens, and reproduced successfully in a hatchery. The spat oysters grown at 0.2 g make it possible to obtain an experimental production of excellent quality in the pond. This success makes it possible to draw the following conclusions:
The absence of pathology up to the marketing size in a zone contaminated by Bonamia ostreae and Martelia refringens suggests a resistance to parasitoses relating to a particular genetic polymorphism proper to the Corsican strain of the flat oyster Ostrea edulis.
The obtaining, as the first lot, of sizes no 1 and no 0 at 18 months from spat oysters at 0.2 g reveals a high potential of growth of the Corsican strain. The duration of the growing cycle is reduced by more than 50% with respect to the duration of the growing cycle of the flat Belon oyster in the Atlantic.
The condition index is 16% (weight of eatable meat with respect to the total weight), which is higher than that of the Belon oyster in South Brittany. Satisfactory gustatory examinations confirm the remarkable quality of the Corsican strain, from the commercial point of view.

The health status and the resistance to pathogenic agents of the strain were then tested. Such tests were carried out according to the protocols of the O.I.E, (Animal Health World Organisation for bonamiosis and marteliosis):
Cytological examination with a microscope of the tissue print of the heart ventricle and gill: no observation of small spherical or ovoid organisms from 2 to 5 μm inside haemocytes after coloration (Bonamia).
Histopathological examination with a microscope of tissue samples of the gill, the digestive glands, fixed and coloured gonads. No observation of parasite cells from 2 to 5 μm in a free condition or inside haemocytes (Bonamia). No anomaly of the digestive gland, nor presence of spherical organisms from 20 to 30 μm proving the presence of Martelia.
Detection using the monoclonal antibodies immunofluorescence technique showing the resistance of the Corsican strain to the existence of parasites Bonamia and Martelia in the natural environment.
Polymerisation Chain Reaction (PCR): no detection of Martelia refringens with the specific DNA probe targeting the region ITS1 of the parasite.
PCR-RFLP analysis (Restriction fragment length polymorphism): negative control of the DNA extracted from the oyster tissues targeting the fragment SSU rDNA characteristic of the parasite Bonamia ostreae, proving the non-contamination of the Corsican strains.
The molecular in situ hybridization technique (ISH): specific probes of DNA of Bonamia ostreae, fragment SSU rDNA and Martelia refringens, fragment ITS1, are contacted with histological samples of oyster tissues. Negative controls carried out by an observation with a microscope prove the absence of B. ostreae and M. refringens in the tissues of the Corsican strain. Such examinations show that the wild populations of flat oysters from the Pond of Diane are in contact with B. ostreae and M. refringens Bonamia and are not infected by such parasites in this natural environment.

Artificial inoculation tests of these parasites were carried out.
The flat oysters from Corsica were confined for several months in tanks together with oysters strongly contaminated by Bonamia ostreae. The oysters did not develop the disease and answered negatively to the detection tests described hereabove.
The oysters from Corsica received an injection in the mantle cavity of 50 μl of filtered sea water containing 5×10⁶ viable parasites Bonamia ostreae isolated according to the method of Mialhe et al. (1988). Beforehand, the oysters were anaesthetised by bathing in a 3.5% MgCl₂-6H₂O solution enabling the valves to open.

After the injection of the inoculum of the contaminating dose into the mantle cavity, the oysters were kept for one hour out of water before being placed back into the culture tanks filled with sea water aerated by bubbling. After one month of culture, no mortality was observed and the oysters answered negatively to the tests of detection of Bonamia ostreae described hereabove. This technique of experimental infection by bathing or by injection into the mantle cavity cannot be used for testing the resistance to Martelia refringens in the absence of direct horizontal transmission of this parasite.

Such experiments show that the wild flat oysters from Corsica and Sardinia, more particularly from the pong of Diane, of Urbino, the gulfs of Porto Vecchio and Santa Manza, the lagoons in Sardinia, is 100% resistant to the parasite Bonamia ostreae, a protozoa of the Haplosporides family. Such experiments strongly contradict the state of the scientific knowledge according to which the autochthon strain of Ostrea edulis would be decimated by a disease caused by a protozoa, erroneous mentions being in the literature (MINICONI R., 2000, Les fruits de mer des côtes de Corse, Editions Alain Piazzola, P. 90 [9]) de facto referring to tests cultures of spat oysters imported from the Atlantic, non-resistant and/or infected.

The cross-checking of all the observations made on the flat oyster from Corsica show the resistance of the wild strain to haplosporides, protozoa, martelias, parasites, opportunistic pathogenic agents and external contaminating agents calling to the general mechanisms of cellular immunity (haemocytes) and humeral immunity of the bivalves, the immune system of which remains non-adaptive, i.e. without any immunological memory.

Other wild populations of flat oysters from the Mediterranean Sea were tested according to the previous protocol and showed a total resistance to parasites Bonamia ostreae and Martelia refringens. This concerns wild populations from Corsica, Morocco (lagoon of Nador), Tunisia (Gulf of Gabes), Libya (lagoons close to the Tunisian border and Greece).

### Example 2

### Resistant Oyster Ostrea edulis from the Pond of Diane in Corsica

Wild oysters were collected from the Pond of Diane, an area contaminated by the pathogenic agents Bonamia ostreae and Martelia refringens and reproduced in hatcheries. The wild oysters were directly taken from a natural site and are resistant to pathogenic agents.

The wild oysters sampled are oysters with a diameter above 60 mm and are of the first farming age.

Once the sampling made, the oysters were placed in a vessel with a volume of 20 L filled with 20 L of sea water having a salinity of 37‰, a temperature of 13° C. and a pH of 8.1 and sent to the hatchery. The oysters sampled were marked prior to their packing using labels stuck with an epoxy glue.

### Example 3

### Non-Resistant Oysters

In this example, an immature oyster of the Belon quality (“Quiberon” strain, South Brittany) was chosen, from a natural collection, with a size of 60 mm. The oyster used for carrying out the method of the invention is an oyster expressing no pathology.

### Example 4

### Maturation of the Oysters for Fertilization

After the sampling of the oysters to be hybridized in example 2 and 3, these are isolated and associated two by two, which means that a sensitive oyster is associated with a resistant oyster. Twenty couples are thus constituted. The couples are then placed into 20 previously filled tanks, each having a unit volume of 20 litres. Each tank has previously been filled with 20 litres of sea water with a salinity of 37‰. The pH of water is 8.1. The initial temperature of water is 13° C. and it is raised to 20° C. within two weeks. Water is oxygenated through a system of pumps with an airflow rate of 20 L/hr for each tank.

The supply of water during maturation is provided through a closed water circuit and isolated for each tank. The physicochemical characteristics of water are kept constant along the maturation.

The maturation of the oysters is carried out over a period of 15 to 90 days through an increase in photoperiod from 9 hours to 15 hours and a progressive increase of the water temperature reaching 20 to 30° C.

During this period of maturation, the food supply was provided by addition into the medium of unicellular algae of the strain Isochrysis galbana, Skeletonema costatum, Pavlova lutheri, Chaetoceros calcitrans, originating from the hatchery or refrigerated concentrated pastes from the SATMAR company. The food supply is ad lib, three meals a day, as long as the feeding of the oysters is observed. The food supply is simultaneously completed by additions of organic materials more particularly originating from wastes from the pools for young fish rearing.

Maturation is checked through the observation of the stages of maturity of the gonads using techniques known to the persons skilled in the art in an anaesthetic bathing using magnesium chloride (MgCl₂) Gagnaire B., 2005, “Etude des effets de polluants sur les paramètres hémocytaires de l'huître creuse Crassostrea gigas—Interactions entre environnement, mécanismes de défense, et maladies infectieuses”, a doctorate thesis, La Rochelle University, 412 pages, [10].

The oysters are mature for the induction of the laying of gametes when the maturation of gonads reaches stage 3.

### Example 5

### Induction of the Emission of the Gametes and Fertilization of the Gametes

The induction of the emission of the gametes is carried out on oysters having been submitted to maturation as per example 4.

The induction of the emission of the gametes is carried out under the same conditions, using the same means and with the same couples of oysters as in example 4.

Prior to the induction, the circulation of water is stopped in order to avoid the dispersion of the gametes in the culture medium.

The induction of the emission of the gametes is obtained by a thermal shock. The temperature is alternately reduced and increased from 4° C. to 7° C. with minimum values between 23° C. and 30° C. and maximum values between 30° C. and 37° C.

Males spawn first which induces chemically the emission of female gametes by female oysters.

The spermatozoids released in the medium are filtered by the female. Fertilization occurs in the mantle cavity thereof, which will incubate larvae for eight to ten days before expulsing them to the outside in the number of one million per female.

During the step of incubation of larvae in the mantle cavity, water is re-circulated. Larvae are fed with phytoplankton. The phytoplankton used for feeding the larvae is composed of Isochrysis galabana, Pavlova lutheri, Chaetoceros forma pumilum, originating from mass cultures in tanks located outside the hatchery and completed, if required, by algae concentrated paste originating from the SATMAR Company. The size of the phytoplankton used is between 20 to 40 μm for the larvae in the first stage, from 50 to 200 μm upon the metamorphosis up to the adult stage. The daily quantity of phytoplankton added to the medium at lib while observing the circulation of food inside the tanks with the circulation of water being interrupted during meals.

### Example 6

### Collection and Fixation of Larvae

The collection of the larvae emitted in the medium of example 5 is carried out using a screen. The conditions of collection and fixation of the larvae are identical to those of example 3. The screen used has measures with a diameter of 120 μm. Using a screen makes it possible to collect larvae existing in a cultural medium. These are grouped into an homogeneous batch as a function of their parents. The grouping is carried out in tanks, the bottom of which is covered with micro-crushed oyster and mussel shells calibrated on a screen between 250 μm and 500 μm.

The volume of the tanks is between 2 and 5 m³. The tanks are filled with water having a salinity of 37‰, a ph of 8.2 and a temperature from 20 to 25° C. The tanks in close circuits are oxygenated with a pump having an airflow rate between 2 and 5 m³/hr. After eight to ten days of incubation, the larvae are fixed on development supports. The method for fixing larvae is a conventional method for fixing larvae on supports, more particularly described in IFREMER's technical documentations, Ifremer, 2007, Datasheet on aquaculture dated 17 Mar. 2007, “Les écloseries: cas de l'huître creuse” [11] and in Helm, M. M., Bourne, N., Lovatelli, A., (comp./ed.) Ecloseries de bivalves, Un manuel pratique. FAO document technique sur les peches No 471, Rome, FAO. 2006. 184 p. [12].

### Example 7

### Resistant and Non-Resistant Oysters

The tables hereinunder show other examples of resistant and non-resistant oysters for the method of the invention;

Table 1: resistant Mediterranean oyster O. edulis
Table 2: resistant Mediterranean oyster O. edulis
Table 3: non-resistant Mediterranean oyster O. edulis
Table 4: Non-resistant oyster O. edulis
Table 5: Other non-resistant oysters

TABLE 1
resistant Mediterranean oysters Ostrea edulis

| | | Location of the | | Ecological characteristics | | |
|---|---|---|---|---|---|---|
| Species | Origin | strain | Status | Stage | Temperature | Salinity |
| Ostrea | Mediterranean | CORSICA (Diane and | Wild | Infra- | Hot temperate | Normal |
| edulis | | Urbino) | | littoral | | |
| Ostrea | Mediterranean | MOROCCO (Nador) | Wild | Strand | Sub-tropical | High |
| edulis | | | | | | |
| Ostrea | Mediterranean | LIBYA (lagoons) | Wild | Infra- | Sub-tropical | High |
| edulis | | | | littoral | | |
| Ostrea | Mediterranean | TUNISIA (Gabes, | Wild | Strand | Sub-tropical | High |
| edulis | | Kerkennah) | | | | |
| Ostrea | Mediterranean | GREECE (Aegean | Wild + culture | Infra- | Hot temperate | Normal |
| edulis | | Sea) | | littoral | | |

TABLE 2
resistant Mediterranean oyster Ostrea edulis

| | | | | Ecological characteriztics | | |
|---|---|---|---|---|---|---|
| Species | Origin | Location | Status | Stage | Temperature | Salinity |
| Ostrea | Mediterranean | SPAIN (Murcia, mar | Wild | Infra- | Hot | Normal |
| edulis | | Menor) | | littoral | temperate | |
| Ostrea | Mediterranean | TURKEY (Anatoly, | Wild | Infra- | Hot | Normal |
| edulis | | Bosphorus) | | littoral | temperate | |
| Ostrea | Mediterranean | Ukraine, Sevastopol, | Wild + culture | Infra- | Temperate | Normal |
| edulis | | Crimea | | littoral | | |
| Ostrea | Mediterranean | RUSSIA, GEORGIA, | Wild | Infra- | Temperate | Normal |
| edulis | | ROMANIA | | littoral | | |
| Ostrea | Mediterranean | CROATIA, East | Wild | Infra- | Temperate | Normal |
| edulis | | Adriatic Sea | | littoral | | |
| Ostrea | Mediterranean | SPAIN, Balearic | Wild | Infra- | Hot | Normal |
| edulis | | Island, Minorque | | littoral | Temperate | |
| Ostrea | Mediterranean | EGYPT, Alexandria | Wild | Infra- | Sub-tropical | Variable |
| edulis | | | | littoral | | |
| Ostrea | Mediterranean | France, Camargue, | Wild | Infra- | Temperate | Variable |
| edulis | | Port St Louis | | littoral | | |

TABLE 3
non-resistant Mediterranean oysters Ostrea edulis

| | | | | Ecological characteriztics | | |
|---|---|---|---|---|---|---|
| Species | Origin | Location | Status | Stage | Temperature | Salinity |
| Ostrea | Mediterranean | FRANCE, Thau, | Wild + culture | Infra- | Hot | Normal |
| edulis | | Languedoc | | littoral | temperate | |
| Ostrea | Mediterranean | ITALY, Venice, north | Wild + culture | Infra- | Temperate | Normal |
| edulis | | of Adriatic Sea | | littoral | | |

TABLE 4
Non-resistant oysters Ostrea edulis from the Atlantic, the PACIFIC and
the INDIAN ocean

| | | | | Ecological characteriztics | | |
|---|---|---|---|---|---|---|
| Species | Origin | Location | Status | Stage | Temperature | Salinity |
| Ostrea | Atlantic | FRANCE, Belon, South | Wild + culture | Strand | Cold | Variable |
| edulis | | Brittany | | | temperate | |
| Ostrea | Atlantic | FRANCE, Cancale, Manche | Wild + culture | Strand | Cold | Variable |
| edulis | | | | | temperate | |
| Ostrea | Atlantic | SPAIN, Galicia | Wild + culture | Strand | Temperate | Normal |
| edulis | | | | | | |
| Ostrea | Atlantic | PORTUGAL | Wild + culture | Strand | Temperate | Normal |
| edulis | | | | | | |
| Ostrea | Atlantic | GREAT BRITAIN | Wild + culture | Strand | Cold | Variable |
| edulis | | | | | temperate | |
| Ostrea | Atlantic | IRELAND | Wild + culture | Strand | Cold | Variable |
| edulis | | | | | temperate | |
| Ostrea | Atlantic | THE NETHERLANDS | Wild + culture | Strand | Cold | Variable |
| edulis | | | | | temperate | |
| Ostrea | Atlantic | DENMARK | Wild + culture | Strand | Cold | Variable |
| edulis | | | | | temperate | |
| Ostrea | Atlantic | CANADA and the U.S.A. | Wild + culture | Strand | Temperate | Variable |
| edulis | | (East) | | | | |
| Ostrea | Pacific | CANADA, U.S.A. (West) | Wild + culture | Strand | Cold | Variable |
| edulis | | | | | temperate | |

TABLE 5
Non-resistant oysters of a genus or species different from Ostrea edulis

| Species | Origin | Location of the strain | Status | Status of the exploitation |
|---|---|---|---|---|
| Ostrea | Pacific | CHINA, KOREA, JAPAN | Wild + culture | Endangered species |
| denselamellosa | | | | Declining exploitation |
| Ostrea puelchana | Atlantic | BRAZIL, ARGENTINA | Wild + culture | Threatened exploitation in |
| | | | | Argentina |
| Ostrea folium | Atlantic | From MOROCCO to GABON, | Wild + culture | Experiment cultures in |
| | Indian | INDIA, AUSTRALIA, MALAYSIA | | Malaysia |
| | Ocean | | | |
| Ostrea permollis | Atlantic | WEST INDIES, the UNITED | Wild + culture | |
| | | STATES (Florida, North | | |
| | | Carolina) | | |
| Ostrea stentina | Atlantic | AFRICAN COASTS + SOUTH | Wild + culture | Too small to be marketed |
| | Indian | MEDITERRANEAN SEA | | |
| | Ocean | | | |
| Ostrea angasi | Pacific | AUSTRALIA | Wild + culture | Tested exploitation in |
| | | | | Australia |
| Ostrea conchapila | Pacific | U.S.A., CANADA (from | Wild + culture | Tested exploitation |
| | | California to Alaska) | | |
| TRiostrea Chilensis | Pacific | CHILE, NEW ZEALAND | Wild + culture | Declining culture |
| | | | | (parasitosis) |
| Crassostrea | Atlantic | CANADA and the U.S.A. | Wild + culture | Parasitosis |
| virginica | | (East) | | Declining Culture and |
| | | | | exploitation |
| Crassostrea gasar | Atlantic | WEST AFRICA | Wild + culture | Uncompleted tests for |
| | | | | domestication |
| Crassostrea | Indian | EAST AFRICA | Wild + culture | Uncompleted tests for |
| rhizophorae | Ocean | | | domestication |

### 8. Other Hybridization Examples

The tables hereinunder show other examples within the scope of the present invention. Carrying out the hybridization of the invention makes it possible to acquire resistance to pathologies with a view to an extended exploitation of domestic oysters over time, the characteristics of which have previously been selected to meet the physical, biological and commercial obligations of the concerned culture media.

TABLE 6
Examples of crosses for obtaining resistant oysters
according to the method of the invention.

| | | Oysters Ostrea edulis vulnerable to parasites | | | | |
|---|---|---|---|---|---|---|
| | | | | | Ostrea | |
| | | Ostrea | | | edulis | |
| | | edulis | Ostrea | Ostrea | WEST- | Ostrea |
| | | EAST- | edulis | edulis | ATLANTIC | edulis |
| | | ATLANTIC | THAU | VENICE | Canada, | EAST- |
| | | France | (France) | Italy | the U.S.A. | PACIFIC |
| resistant | Ostrea | + | + | + | + | + |
| Mediterranean | edulis | | | | | |
| oysters | CORSICA | | | | | |
| | Ostrea | + | ? | ? | + | + |
| | edulis | | | | | |
| | MOROCCO | | | | | |
| | Ostrea | ? | ? | + | ? | ? |
| | edulis | | | | | |
| | MURCIA | | | | | |
| | Ostrea | ? | ? | + | ? | ? |
| | edulis | | | | | |
| | TURKEY | | | | | |

| | | Oysters Ostrea edulis vulnerable to parasites | | | | | | | |
|---|---|---|---|---|---|---|---|---|---|
| | | Ostrea edulis | Ostrea | Ostrea | Ostrea | Ostrea edulis | Ostrea | Ostrea edulis | Ostrea |
| | | SOUTH | edulis | edulis | edulis | GREAT | edulis | THE | edulis |
| | | BRITTANY | MANCHE | GALICIA | PORTUGAL | BRITAIN | IRELAND | NETHERLANDS | DENMARK |
| Mediterranean | Ostrea | ? | ? | + | + | ? | ? | ? | ? |
| oysters | edulis | | | | | | | | |
| resistant | CORSICA | | | | | | | | |
| to parasites | Ostrea | + | + | ? | ? | + | + | + | + |
| | edulis | | | | | | | | |
| | MOROCCO | | | | | | | | |
| | Ostrea | ? | ? | + | ? | ? | ? | ? | ? |
| | edulis | | | | | | | | |
| | MURCIA | | | | | | | | |
| | Ostrea | ? | ? | + | ? | ? | ? | ? | ? |
| | edulis | | | | | | | | |
| | BALEARIC | | | | | | | | |
| | ISLANDS | | | | | | | | |
| | Ostrea | ? | ? | ? | ? | + | + | + | + |
| | edulis | | | | | | | | |
| | UKRAINE | | | | | | | | |
| | Ostrea | ? | ? | + | ? | ? | ? | ? | ? |
| | edulis | | | | | | | | |
| | TURKEY | | | | | | | | |

+: Hybrids
?: Not tested yet

The hybrids obtained with the method of the invention such as previously mentioned have particular characteristics required for such hybridization, which meet the needs for conventional productions of flat oysters. The hybrids are resistant to bonamiosis and martiolosis. In addition, they are resistant to opportunistic pathogenic agents. Hybrids have a coarseness and a tolerance to the amplitude of variations in the medium, for example land emergence or submersion by tides, temperature, salinity. They have a high growth potential. They are adapted to the culture in intertidal area, in water rich in nutriments and organic material, to constraints from the weather heating of littoral waters. Finally, hybrids are tolerant to anoxia, desiccation and transportation constraints.

### Example 9

### Hybridization Between the Wild Oysters from Ponds In Corsica and Oysters from the Lagoon of Nador in Morocco

The wild oysters from ponds in Corsica and oysters from the lagoon of Nador were crossed according to the method of the invention. In this case, this is a cross between two resistant oysters. The proximity of Nador to the Strait of Gibraltar causes tides which can reach two metres in the lagoon and causes temporary land emergence of natural populations of Moroccan oysters. The hybridization of oysters from the Pond of Diane with those from Nador makes it possible to create hybrids resistant to lethal pathologies, with an important growth adapted to the constraints from tides in the Atlantic, tolerant to the increasing temperatures resulting from the weather heating and resistant to desiccation during the transportation dry, to be sold.

The production of hybrid spat oysters was compared to that of spats from Nador oysters produced simultaneously in hatcheries. Hybrid has an average daily growth higher by 30% than that of the control batch of Moroccan spat oysters during the month following the metamorphosis. In addition, the related size of domestic hybrid spat oysters is much more homogeneous than that in the control batch which seem to be extremely heterogeneous. The heterosis effect (hybrid vigour) induced by the control hybridization is then confirmed within the scope of the production of domestic flat oysters with a strong zoo-technical potential.

The thus created domestic hybrid F1 then solves the problem of degeneration of flat oyster “Belon” in oyster farms on the Atlantic coasts.

Wide adaptations acquired thanks to such hybridization according to the method of the invention consequently meet the needs for conventional productions of flat oysters in Portugal, Galicia, Britanny, Normandy, Ireland and the Netherlands. Hybrids are resistant to bonamiosis and marteliosis. They are also resistant to opportunistic pathogenic agents. Hybrids have a coarseness and a tolerance to the amplitude of tides and the variations in the medium, for example temperature and salinity. They have a high growth potential. They are adapted to culture in intertidal area (culture on the tidal zone), in waters rich in nutriments and organic material (refining in rias, refining in oyster pits), to the constraints resulting from the heating of littoral waters. Finally, hybrids are tolerant to anoxia, desiccation and constraints connected with transportation, a resistance which was demonstrated when sending packets form Corsica to market places in Brittany.

### LIST OF REFERENCES

[1] Naciri-Graven et al. (1998)<<Selecting the flat oyster Ostrea edulis (L.) for survival when infected with the parasite Bonamia ostreae>>. J. Exp. Mar Biol. Ecol., 224:91-107.
[2] N. Taris et al. <<Conséquences génétiques de la production de larves d'huîtres en écloserie: étude des processus de dérive et de sélection.>>, Les actes du BRG, 6 (2006) 521-541.
[3] Launey S. et aL <<Geographic structure in the European flat oyster (Ostrea edulis L) as revealed by Microsatellite polymorphism>>. J Hered. 2002 September-October; 93(5):331-51 (2002).
[4] Diaz-Almela et al. <<Reduced female gene flow in the European flat oyster Ostrea edulis>>. J Hered. 2004 November-December; 95(6):510-6. (2004).
[5] Lannan J. E., 1971, <<Experimental self-fertilization of the Pacific oyster, Crassostrea gigas, utilising cryopreserved sperm>>, Genetics, 68: 599-601.
[6] Bougrier et Rabedomanana, 1986. <<Cryopreservation of spermatozoa of the Japanese oyster,>> Crassostrea gigas, Aquaculture, 58: 277-280.
[7] Haffray et al. <<Domestication et amélioration génétique des cheptels piscicoles dans le cadre du SYSAAF>>, INRA Prod. Anim., 2004, 17 (3), 243252.
[8] Gerard A., Naciri-Graven Y., Boudry P., Launey S., Heutebise S., Ledu C., Phelipot P., (1997). Contrôle de la gamétogénèse des huîtres creuses et plates. In: La reproduction naturelle et contrôlée des Bivalves cultivés en France, Devauchelle N., Barret J., Salaun G, (1997), DRV/RA/RST 97-11, Werner Brest, 217 pp,
[9] MINICONI R., (2000) Les fruits de mer des cotes de Corse, Editions Alain Piazzola, p 90.
[10] Gagnaire B., 2005, <<Etude des effets de polluants sur les paramétres hémocytaires de l'huître creuse Crassostrea gigas—Interactions entre environnement, mécanismes de défense, et maladies infectieuses>>, thése de Doctorat de l'Université de La Rochelle, 412 pp.
[11] Ifremer 2007 Fiche aquaculture du 17 mars 2007, <<Les écloseries: cas de l'hûtre creuse>.
[12] Helm, M. M., Bourne, N., Lovatelli, A., (comp./éd.) Ecloseries de bivalves, Un manuel pratique. FAO document technique sur les pêches No 471. Rome, FAO. 2006. 184 p.
[13] Bower, S. M., Mc Gladdery S. E., Price I. M. (1994) Synopsis of infectious diseases and parasites of commercially exploited shellfish. Annual Review of Fish Diseases 4:1-199.
[14] Bower, S. M., Mc Gladdery S. E (2003) Synopsis of infectious diseases and parasites of commercially exploited shellfish. URL: http://wvvw-sci.pac.dfo-mpo.gc.ca/sheldisititle e.htm
[15] Taris N. et al., 2007, Evidence of response to unintentional selection for faster development and inbreeding depression in Crassotrea gigas larvae, Aquaculture, Vol. 272, supplement 1, pages S69-S79, Supplement: Genetics in aquaculture IX.
[16] Anon., 2008, “L'ostréiculture marquée par les épizooties”, Le Marin no 3183, Friday Jul. 11, 2008, 5.

1. A method for obtaining oysters resistant to pathogenic agents, characterized in that it comprises the hybridization of a Mediterranean oyster Ostrea edulis resistant to said pathogenic agents and of a non-resistant oyster of the opposite sex.

2. A method according to claim 1, wherein said pathogenic agents are selected among bacteria, parasites and viruses.

3. A method according to claim 1, wherein the non-resistant oyster is selected from the group including the species Ostrea edulis, Ostrea angasi, Ostrea conchaphila, Ostrea luridea, Ostrea denselamellosa, Ostrea puelchana, Ostrea folium, Ostrea stenting Tiostrea chilensis, Crassostera virginica, Crassostrea gasar and Crassostrea Rhizophorae.

4. A method according to claim 2, wherein the pathogenic agent is responsible for a disease selected among the group including bonamiosis, marteliosis, haplosporidosis, microcytosis, perkinsosis and/or irivovirosis.

5. A method according to claim 2, wherein said pathogenic agents are responsible for Bonamiosis and/or Marteliosis.

6. A method according to claim 1, wherein the hybridization includes the following steps:
a) supplying a Mediterranean oyster Ostrea edulis resistant to said pathogenic agents,
b) supplying a non-resistant oyster to said pathogenic agents, the sex of which is opposite to the one of said resistant oyster Ostrea edulis,
c) placing together said oysters in a tank containing water having a salinity enabling hybridization,
d) maturation of said oysters in said tank, with an increasing photoperiod with food supply sufficient for said maturation,
e) induction of the emission of male gametes using an induction agent applied to the oysters,
f) fertilization of the female gametes by the male gametes emitted in step e),
g) incubation of larvae for 8 to 10 days,
h) feeding of the larvae obtained in step g) by phytoplankton so as to obtain eyed larvae,
i) collection of the obtained eyed larvae, and
j) fixation of said larvae on a development support in order to obtain at least one oyster resistant to said pathogenic agents.

7. A method according to claim 6, wherein the steps e) to g) are carried out in vitro, with the gametes being obtained by scarification of the gonads.

8. A method according to claim 6, wherein the steps e) to g) are carried out in vivo, with the step f) of fertilization of the gametes emitted in step e) being carried out after the filtration of the gametes in the mantle cavity of the female oyster and the step g) of incubation being carried out in the mantle cavity of the female oyster so as to obtain an expulsion of larvae.

9. A method according to any one of claims 6 to 8, wherein said tank is continuously supplied by a circuit of said water and wherein for the implementation of step e) said water circuit is closed.

10. A method according to claim 9, wherein said water circuit is isolated.

11. A method according to any one of claims 6 to 8, wherein the maturation of step d) is carried out at a temperature between 20 and 30° C.

12. A method according to claim 6, wherein said tank is a hatching tank.

13. A method according to claim 6, wherein the induction means such as defined in step e) is a thermal shock and/or at least a protein.

14. A method according to claim 13, wherein the thermal shock is carried out through the successive reduction and increase of the temperature to values between 5 and 55° C.

15. A method according to claim 6, wherein said food supply is composed of living unicellular algae grown in a hatchery.

16. A method according to claim 15, wherein the unicellular algae are selected from the group including Isochrysis galabana, Skeletonema costatum, Pavlova lutheri, Chaetoceros calcitrans, Tetraselmis sp.

17. A method according to claim 6, wherein step i) is carried out 8 to 10 days after the expulsion of larvae.

18. A method according to claim 6 wherein the development support of step i) is selected from the group including micro-crushed shells and/or a screened material between 250 and 500 μm.

19. A method according to claim 1, wherein the resistant oyster Ostrea edulis has a level of carbohydrate storage materials appropriate for hybridization.

20. A method according to claim 1, wherein the Mediterranean resistant oyster Ostrea edulis is of the first farming age and has a diameter above 60 mm.

21. A method according to claim 1, wherein the resistant oyster Ostrea edulis and the non-resistant oyster are selected after the period of sexual latency.

22. A method according to claim 1, wherein the hybridization is carried out on only one farming season.

23. A method according to claim 1, wherein the non-resistant oyster is a strain of oyster from the Atlantic, the Pacific or the Indian Ocean.

24. An oyster obtained by a method according to any one of claims 1, 6, 7 and 8.
